(19) United States
(12) Patent Application Publication
(10) Pub. No.: US 2012/0126524 A1
(43) Pub. Date: May 24, 2012

(54) AN INSERT FOR A PUBLICATION THAT COMPRISES LEAVES, AND A PUBLICATION CONTAINING THE INSERT

(75) Inventor: Sylvie Georgette Legastelois, Asnieres Sue Seine (FR)

(73) Assignee: CHANEL PARFUMS BEAUTE, Neuilly Sur Seine (FR)

(21) Appl. No.: 13/376,921

(22) PCT Filed: Jun. 24, 2010
(86) PCT No.: PCT/FR10/00465

§ 371 Date: Feb. 2, 2012

(30) Foreign Application Priority Data
Jun. 26, 2009 (FR) 0903136

(51) Int. Cl. B42D 1/00

(52) U.S. Cl. 281/38

(57) ABSTRACT

The invention provides a publication insert that comprises a sheet that is formed of four panels, two outer panels and two inner panels, the two outer panels having the same height and width, and the two inner panels having the same height and width, the panels being connected together via score lines, each of the two outer panels being extended by a joint strip along its edge remote from the score line connection with the inner panel, and the width of an inner panel being smaller than the width of an outer panel. The invention also provides a publication presenting such an insert, and having joint strips that are held captive in the binding joint.

The invention relates to an insert for inserting in an illustrated magazine or more generally a publication that comprises a plurality of leaves. The invention also relates to a publication containing the insert.

The purpose of such an insert is to enable a photograph, a text, or other matter to be published on a double-page spread under the best possible conditions.

Currently, when a magazine is open and placed flat on a surface, all of the leaves form a rounded shape at the binding edge that is usually known as the joint. At the joint, the leaves are oriented perpendicularly to the plane on which the main portions of the leaves rest. The rounding or the rounded shape adds a third dimension to the illustration that is printed on the pages.

It is thus very difficult to design a photograph or an advertisement that extends in continuous manner over a double-page spread. For the reader, the middle portion of the photograph is deformed by the rounding, and a strip in the middle of the photograph is hidden in the joint. Thus, the middle portion of the photograph is seen to be deformed, together with a discontinuity in said middle portion.

One solution consists in printing, on each of the pages, a respective portion of a photograph together with an additional strip that is also visible on the portion of the photograph on the other page. Thus, the continuity of the photograph is reconstituted once the two additional strips are held captive in the joint. However, this does not solve the problem of the third dimension created by the rounding of the leaves.

Another problem to which it is necessary to pay attention is matching the two photograph portions in the height direction of the pages. It can happen that the two portions are offset.

Thus, in general, the rendering of a photograph on a magazine double-page spread is mediocre.

Another presentation technique consists in providing a double spread that opens laterally outwards. By adding flaps, it is possible to present a photograph or an advertisement that extends over a width of two, three, four, or even more, pages. By way of example, such a presentation of an insert is usually known under the name “Trench door” or “Gatefold” depending on the number and the dimensions of the various panels, and in particular it is described in U.S. Pat. Nos. 2,316,786 or 3,866,900.

In that configuration, opening the insert requires the reader of the magazine to perform a particular manipulation that greatly reduces the surprise effect that is obtained when discovering the inside of the insert on turning the pages of the magazine naturally.

A first object of the invention is to propose a magazine insert that is improved in that it enables a reproduction, a photograph, or other matter to be presented on a double-page spread without the photograph or the reproduction being deformed significantly in the connection zone between the two pages, and in that the two pages of the insert are deployed by a natural movement that is similar to the movement for turning the pages of the magazine.

Another object of the invention is to propose an insert that offers novel possibilities for creating visual presentation effects.

Thus, in the invention, the insert comprises a sheet that is made up of four panels, two outer panels and two inner panels, the two outer panels having the same height and width, and the two inner panels having the same height and width, each outer panel being connected to an inner panel via a score line, and the two inner panels being connected together via a score line, each score line extending in the height direction of the panels, each of the two outer panels being extended by a joint strip along its edge remote from the score line connection with the inner panel, and the width of an inner panel being smaller than the width of an outer panel.

The publication of the invention comprises a plurality of leaves that are assembled together at a binding joint, and it is characterized in that it includes an insert as described above.

According to another characteristic, the joint strips of the outer panels of the insert are held captive in the binding joint.

The invention can be better understood with reference to the following description and to the accompanying drawings that are attached thereto.

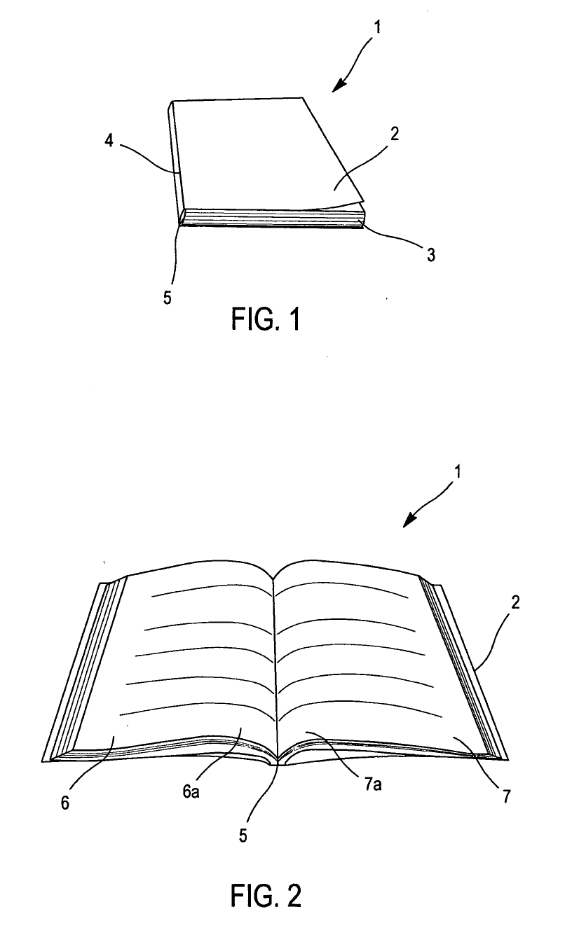

FIG. 1 is a diagram showing a traditional magazine.

FIG. 2 shows the FIG. 1 magazine open.

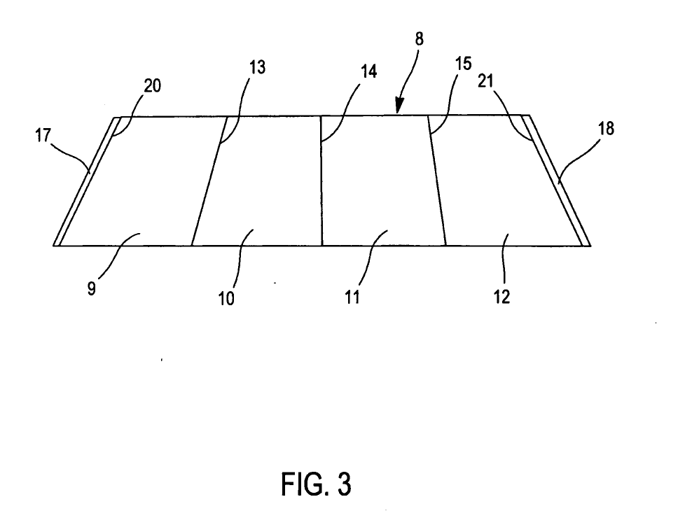

FIG. 3 shows an insert of the invention when developed.

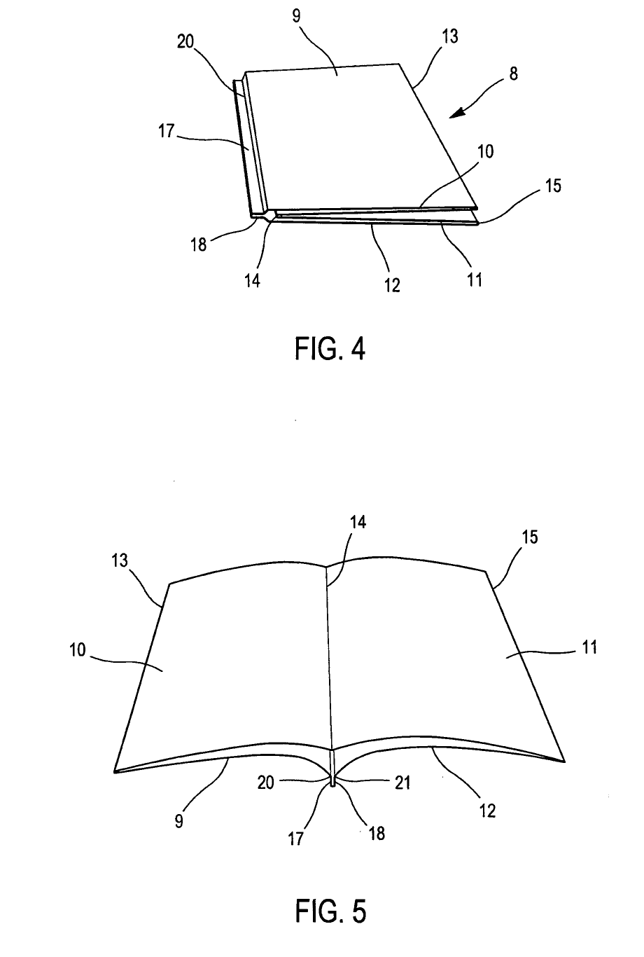

FIG. 4 is a diagram showing the FIG. 3 insert when folded and assembled.

FIG. 5 shows the FIG. 3 insert in its deployed state.

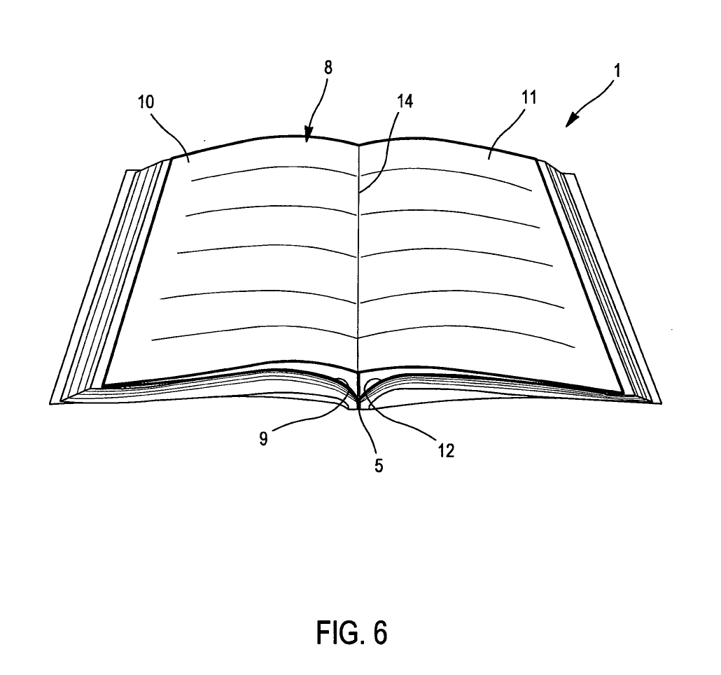

FIG. 6 shows the FIG. 2 magazine open at the double page of the insert.

In known manner, the magazine 1 that is shown in diagrammatic manner in FIG. 1 comprises a cover 2 that is folded over a plurality of leaves 3 that are stacked one on top of another. The leaves 3 and the cover 2 are bound at the spine 4 of the magazine by any appropriate means and, for example, by adhesive that binds the edges of the leaves together. A common technique of binding together the leaves and the cover is known as a “glued square back”. The leaves are assembled in the normal reading order, then they are cut by means of a paper cutter so as to obtain a completely flat spine. The book formed in this way is placed on its spine, then cut so as to obtain notches that enable the adhesive to penetrate, providing perfect adhesion of each leaf on the spine of the cover. The cover is then added. Optionally, the three non-bound sides are cut so that their edges are quite regular.

Other assembly techniques are also suitable. For example, the leaves may be assembled together in signatures that are bound with adhesive to one another and with the cover.

Along the spine, each of the leaves presents a strip that supports the binding adhesive. Together, the adhesively-bound strips form what is usually known as the joint. Thus, the magazine 1 presents a joint 5 along the spine 4. For a current magazine, the width of the joint lies in the range 3 millimeters (mm) to 6 mm, and is often equal to 5 mm.

In conventional manner, the leaves of the magazine are rectangular, and by convention they are said to have a height and a width, the spine of the leaves being oriented in the height direction, and the width being oriented perpendicularly to said direction.

Usually, the leaves of a magazine are made of paper of weight lying in the range 65 grams per square meter (g/m²) to 110 g/m², preferably in the range 65 g/m² to 80 g/m². The cover itself is made out of paper of weight that is greater.

Preferably, the invention applies to binding the leaves or the signatures by adhesive. But other binding techniques can also be used.

FIG. 2 shows the magazine 1 in its open position lying on a plane surface (not shown). This figure shows the rounded shapes that the leaves 6 and 7 present in the zones 6a and 7a. This rounding may vary depending on where the magazine is opened. It may also vary depending on the way in which the reader holds the magazine in the hand. As a general rule, the rounding is similar on both sides of the spine when the magazine is open towards the middle of its thickness, and the more the number of leaves on one side increases, the more the rounding of the other side is pronounced, with the spine tending to tilt naturally towards the side containing the greater number of leaves. Under all circumstances, the magazine presents at least one rounded shape that deforms the illustration of the page.

FIG. 3 shows an insert 8 when developed.

The insert 8 comprises a sheet that is made up of four flexible panels 9, 10, 11, and 12 that are connected together in pairs via score lines 13, 14, 15 that form hinges. The score lines are oriented in the height direction of the panels, such that the panels extend beside one another. Preferably, the four panels and their score lines are made as a single piece.

The height of the panels is not greater than the height of a leaf. Preferably, it is a little less, i.e. it is a few millimeters less.

The width of the panels is determined as follows. The outer panels 9 and 12 have the same width that is not greater than the width of the leaves of the magazine. The width in question of the leaves of the magazine is their working width, i.e. the width of the visible portion of the page. Preferably, the width is a little less than the working width. The width of the inner panels 10 and 11 is less than the width of the outer panels. In order to obtain the desired effect, the width is less by 1 centimeter (cm) to 4 cm. Good results have been obtained with outer panels having a width of 23 cm, and with inner panels having a width of 21 cm. Good results have also been obtained with outer panels of 22 cm and inner panels of 21 cm, or even with outer panels of 26 cm and inner panels of 22.5 cm. In the embodiment shown, each of the outer panels is extended by a strip 17, 18 having a width that is not greater than the width of the joint strip of the magazine, i.e. not greater than 5 mm for a joint that is 5 mm wide. Each outer panel 9, 12 is connected to a joint strip 17, 18 via a score line 20, 21 that extends along the height of the outer panels. The score lines 20 and 21 are preferable, but they are not essential, with it being possible for a panel to be continuous with the joint strip that is associated therewith.

The insert is made out of a material that is flexible but that nevertheless presents stiffness that is greater than the stiffness of the leaves of the magazine. For example, the panels may be made out of paper having weight lying in the range 180 g/m² to 250 g/m², preferably in the range 200 g/m² to 225 g/m², for leaves made out of paper having weight lying in the range 65 g/m² to 80 g/m². A paper that is too light in weight is not desirable since the panels are too flexible, in particular the outer panels would not have sufficient stiffness to make the inner panels taught, and a paper that is too heavy is not desirable either since the panels would then be too stiff, which would hinder deployment of the insert. In addition, the insert would be too thick in the magazine. Other materials are also suitable, e.g. a sheet of plastics material, or a multilayer material.

FIG. 4 shows the insert 8 folded and assembled, which insert forms a leaf that is ready to be inserted into a magazine. For the purpose of clarity, the thickness dimensions of the insert are exaggerated in the figure.

Assembly consists in folding the panels on one another about the score lines so that they are stacked, and in adhesively bonding together the two joint strips 17 and 18. It is preferable to assemble the joint strips together at this stage, i.e. before inserting the insert between the leaves of the magazine, so as to avoid the panels sliding against one another while the magazine is being assembled, since this would tend to skew the insert. Solutions other than adhesive binding exist. For example, it is possible to mechanically fasten the two joint strips together using complementary shapes that interfit in one another, e.g. using hook-shaped cutouts, or even tabs of one strip that penetrate into slots in the other strip.

In this figure, it can clearly be seen that as a result of the difference in width between the outer and inner panels, the score line 14 between the two inner panels is completely set back from the joint strips 17, 18. There is no interference between the score line 14 and the joint strips.

FIG. 5 shows the insert 8 deployed, and FIG. 6 shows the insert 8 deployed between the leaves of the open magazine 1.

The insert is assembled in the magazine while the magazine is being assembled. The insert is placed between two leaves in such a manner that the joint strips 17 and 18 are engaged between the joint strips of the two leaves in question. The insert is positioned in the height direction in such a manner that none of its free edges project beyond the edges of the magazine. The insert is thus held in the joint by the binding of the leaves. It should be observed that after binding, the score line 14 remains completely free.

The insert may be assembled towards the middle of the magazine so that the rounded shapes of the leaves are balanced, but this is not limiting and the insert can in fact be placed at any location.

The insert is deployed by a natural movement that is similar to the movement for turning the leaves of the magazine. When the insert is opened, the outer panels tend to arch, matching the rounding of the leaves against which they rest. The difference in width relative to the inner panels means that the inner panels are taut and are almost in alignment with each other, as shown in FIGS. 5 and 6. Two factors promote the tightening of the inner panels, the weight of the outer panels that causes said outer panels to be rounded close to the rounded shapes of the leaves against which they rest, and the difference in width between the outer and the inner panels. The greater the difference, the greater the tightening. However, too great a difference would cause the outer panels to warp, and that is unattractive.

It is felt that a difference in width lying in the range 5% to 15%, preferably in the range 5% to 10%, of the width of the outer panel makes it possible to obtain good results. For a current magazine, an insert is made having an outer panel of width lying in the range 19 cm to 26 cm, and the difference in width between an inner panel and an outer panel lying in the range 1 cm to 4 cm.

In this way, the insert presents four directly-visible faces that may be used as a communication medium. In particular, the two inner panels offer a single surface over a double-page spread. A photograph or an illustration that is printed on the double-page spread appears to the eyes of a reader without significant deformation at the score line that connects the two inner panels together. The effect in the third dimension is absorbed by the arching of the two outer panels. And since the photograph may be printed directly onto the insert in its entirety, there is no risk of offset between the two photograph portions that would normally exist.

The insert is closed by turning the panels by means of a natural movement that is similar to the movement for turning a leaf. As a result of the memory effect of the score line 14 and of the weight of the outer panels 10 and 11, the inner panels fold naturally between the outer panels 9 and 12 in the configuration that is shown in FIG. 4.

The insert 8 also offers a communication medium on the faces of the panels that are not directly visible. These faces, in particular the faces of the outer panels, form a second plane, which faces may be printed with a background color that contrasts with the first plane of the inner panels so as to show it up. Or it is possible to print text or a logo or any other illustration.

Another variant consists in making one or more cutouts in one or more inner and/or outer panels. The cutouts are revealed by means of the background formed by the face of another panel. By way of example, they may have the shape of a logo.

Other variants are possible that enable attractive visual effects to be obtained.

The above-described invention is not limiting and variants are possible.

In particular, the free edges of the panels may be assembled together so as to form the insert at a location other than between the two outer panels, and in particular at a score line between an outer panel and an inner panel, or between the two inner panels. In this configuration, a panel is extended via a fold that is assembled to the adjacent panel. In this configuration, the joint strips are joined together via a score line.

The dimensions of the insert may be different from the dimensions of the leaves of the magazine.

Finally, the invention is not limited to a magazine, it applies to any kind of publication that comprises leaves.

What is claimed is:

1. A publication insert comprising a sheet that is made up of four panels, two outer panels and two inner panels, the two outer panels having the same height and width, and the two inner panels having the same height and width, each outer panel being connected to an inner panel via a score line, and the two inner panels being connected together via a score line, each score line extending in the height direction of the panels, each of the two outer panels being extended by a joint strip along its edge remote from the score line connection with the inner panel, and the width of an inner panel being smaller than the width of an outer panel.

2. An insert according to claim 1, the difference in width between an outer panel and an inner panel lying in the range 5% to 15% of the width of an outer panel.

3. An insert according to claim 1, the difference in width between an outer panel and an inner panel lies in the range 5% to 10% of the width of an outer panel.

4. An insert according to claim 1, the width of an outer panel lying in the range 19 cm to 26 cm, and the difference in width between an inner panel and an outer panel lying in the range 1 cm to 4 cm.

5. An insert according to claim 1, made out of paper having weight lying in the range 180 g/m² to 250 g/m².

6. An insert according to claim 5, made out of paper having weight lying in the range 200 g/m² to 225 g/m².

7. An insert according to claim 1, the joint strip of the outer panels being not greater than 5 mm in width.

8. An insert according to claim 1, the two joint strips of the outer panels being glued together.

9. A publication that comprises a plurality of leaves that are assembled together at a binding joint, said publication including an insert according to claim 1.

10. A publication according to claim 8, the joint strip of the outer panels of the insert being held captive in the binding joint.
